(19) United States
(12) Patent Application Publication
(10) Pub. No.: US 2025/0262919 A1
(43) Pub. Date: Aug. 21, 2025

(54) ARRANGEMENT FOR MOVING A COVER AND METHOD FOR INSTALLING AN ARRANGEMENT

(71) Applicant: Webasto SE, Stockdorf (DE)

(72) Inventors: Ingo TEUFEL, Stockdorf (DE); Andreas MÄRZ, Stockdorf (DE); Jan ROLWES, Stockdorf (DE)

(21) Appl. No.: 18/857,309

(22) PCT Filed: Apr. 26, 2023
(86) PCT No.: PCT/EP2023/060966

§ 371 Date: Oct. 16, 2024

(30) Foreign Application Priority Data
Apr. 29, 2022 (DE) 10 2022 110 502.4

(51) Int. Cl. B60J 7/057; B60J 7/043; B60J 7/19; B62D 65/06

(52) U.S. Cl. CPC B60J 7/057; B60J 7/043; B60J 7/19; B62D 65/06

(57) ABSTRACT

In an arrangement for moving a cover for a vehicle roof and installation method for installing the arrangement, the arrangement has:
a guide rail, which extends in a longitudinal direction;
an opening lever for raising a rear edge of the cover;
a support carriage, which is held such that it can slide in the guide rail in the longitudinal direction;
a drive lever, which is rotatably coupled at a first end to the opening lever and has a guide element at a second end. The guide element supported between the support carriage and the guide rail so that a movement of the support carriage in the longitudinal direction is transmitted to the opening lever.

An arrangement for moving a cover for a vehicle roof is set out. In addition, a method for installing an arrangement for moving a cover for a vehicle roof is set out, in particular for installing an arrangement described herein.

Such arrangements having a cover for a vehicle roof serve, for example, to raise the cover starting from a closure position in order to close a roof opening for opening by means of a deployment mechanism first in the rear region thereof and then to displace it backward into an open position. DE 10 2006 045 632 B3, the content of which is hereby incorporated by reference, describes in this regard, for example, a so-called spoiler roof.

It is desirable to set out an arrangement for moving a cover for a vehicle roof which enables reliable operation. It is in addition desirable to set out a method for installing an arrangement for moving a cover for a vehicle roof which can be carried out in a reliable manner.

An arrangement for moving a cover for a vehicle roof is set out. In addition, a method for installing an arrangement for moving a cover for a vehicle roof is set out, in particular a method for installing an arrangement described herein. Advantages, features and further developments of the arrangement consequently also apply to the method and vice versa.

According to at least one embodiment, the arrangement has a guide rail which extends in a longitudinal direction. The arrangement has a deployment lever. The deployment lever is configured to raise a rear edge of the cover. The arrangement has a bearing carriage. The bearing carriage is retained in the guide rail so as to be able to be displaced in the longitudinal direction. The arrangement has a drive lever. The drive lever is rotatably coupled at a first end to the deployment lever. The drive lever has at a second end a guide element. The guide element is supported between the bearing carriage and the guide rail. It is thereby possible to transmit a movement of the bearing carriage in the longitudinal direction to the deployment lever.

The drive lever and the bearing carriage cooperate in order to bring about a pivoting of the deployment lever. Consequently, by means of a movement of the bearing carriage and the drive lever, the deployment lever can be pivoted relative to the guide rail in order to raise and lower the rear edge of the cover.

The bearing carriage has, for example, a connection to a locking element. In a first state, the locking element can be displaced in the longitudinal direction relative to a guide rail. In a second state, the locking element is locked against a movement in the longitudinal direction relative to the guide rail. Consequently, the bearing carriage can be displaced in the first state in the longitudinal direction relative to the guide rail. In the second state, the bearing carriage is locked relative to the guide rail. In the first state, the drive lever can be moved by means of the bearing carriage in order to pivot the deployment lever. In the second state, the deployment lever is locked in the deployed position thereof by means of the drive lever and the bearing carriage and the locking element relative to the guide rail. The bearing carriage and the drive lever are in particular components which are configured separately from each other. During operation, the bearing carriage and the drive lever cooperate as described. In this instance, however, particularly no materially engaging connection is formed between the bearing carriage and the drive lever. The movement of the bearing carriage is transmitted to the drive lever by means of a positive-locking connection and/or a non-positive-locking connection.

The arrangement enables a reliable operation with little structural spatial requirement. As a result of the support of the drive lever along the vertical between the bearing carriage and the guide rail, a play-free bearing within the conventional tolerances is possible. The arrangement can be installed in a simple and reliable manner.

According to one embodiment, the guide element has a bearing projection at a first end. The bearing projection is arranged in a recess of the bearing carriage. The bearing projection is supported on a base of the recess. In the assembled state, consequently, a reliable retention of the guide element at the first end is possible and the movement of the bearing carriage can be reliably transmitted to the guide element and the drive lever.

According to another embodiment, the guide element has a protruding projection at a second end. The second end is opposite the first end of the guide element in a longitudinal extent of the guide element. The longitudinal extent corresponds in the assembled and operationally ready state, for example, to the vertical direction or the vertical. The projection protrudes transversely relative to the longitudinal extent. The projection is supported on the guide rail. The projection protrudes along the horizontal or in the transverse direction. Consequently, the projection may enclose the guide rail and be supported on a guide path, which faces the bearing carriage, of the guide rail. The guide element is consequently supported on the guide rail in the vertical direction by means of the projection. The guide element is consequently supported by means of the projection and the bearing projection between the guide rail and the bearing carriage and consequently reliably retained.

According to at least one embodiment, the guide element has a stop at the second end thereof. The stop is supported on a vertical guide path in the guide rail. Consequently, the guide element is supported and retained in the transverse direction on the guide rail. By means of the stop and the projection, the guide element is consequently supported on the guide rail both in the vertical direction and in the transverse direction.

According to at least one embodiment, the guide element is at a second end in direct contact with the guide rail. The guide element has, for example, a plastics material member which is supported between the bearing carriage and the guide rail. The plastics material of the plastics material member is in the assembled state in particular in direct contact with the guide rail and slides during operation along the guide rail.

According to at least one embodiment, the bearing carriage has a protruding region. The protruding region protrudes beside the recess in the vertical direction. The protruding region laterally supports the guide element. In addition, the protruding region serves to enable the guide element to be pushed into the bearing carriage in a reliable manner.

According to at least one embodiment, the method for installing involves providing a guide rail which extends in a longitudinal direction. A bearing carriage is provided. The bearing carriage is retained in the guide rail so as to be able to be displaced in the longitudinal direction. A deployment lever having a drive lever is provided. The drive lever is rotatably coupled at a first end to the deployment lever. The deployment lever has a guide element at a second end. The guide element is moved in a vertical direction in the direction of the deployment lever. The second end of the guide element and the guide rail are redirected relative to each other in a transverse direction. The transverse direction is in particular orientated transversely relative to the longitudinal direction and the vertical direction and the second end of the guide element faces away from the bearing carriage. A first end of the guide element is inserted into the bearing carriage. The second end of the guide element is pivoted into the guide rail and thereby arranged between the bearing carriage and the guide rail. Consequently, the guide element is supported between the bearing carriage and the guide rail.

The method enables a preassembly of the deployment lever with the drive lever and, for example, also with a deployment bearing for the deployment lever. The bearing carriage can be installed in the guide rail independently of the deployment lever and the drive lever. The drive lever can be installed in a simple manner in the guide rail by means of pivoting and insertion into the bearing carriage and pivoting-in and locking. The connection between the drive lever and the locking element can consequently be formed directly in the guide rail. A pre-assembly of the drive lever with a locking element outside the guide rail can be dispensed with. Consequently, a simple assembly with little structural spatial requirement and reliable support and play-free bearing as far as possible is possible.

According to at least one embodiment, the deployment bearing to which the deployment lever is pivotably secured is inserted into the guide rail. The pushing-in of the deployment bearing is carried out prior to the first end of the guide element being inserted into the bearing carriage.

According to embodiments, the arrangement is part of a spoiler roof in which at a rear edge of the cover in the opening direction the deployment lever is first rotated in order to raise the rear edge of the cover. The cover is displaced relative to the deployment lever in the opening direction in order to at least partially release a roof opening. The deployment lever is secured in this instance relative to the remaining vehicle roof and not displaced together with the cover in the opening direction. This is different, for example, in so-called externally guided sliding roofs in which the deployment lever is displaced at the rear edge of the cover together with the cover relative to the remaining vehicle roof in the opening direction.

Other advantages, features and further developments will be appreciated from the following examples explained in connection with the figures. Elements which are identical, similar and have the same effect may be given the same reference numerals in all the figures.

### IN THE DRAWINGS

FIG. 1 shows a schematic illustration of a vehicle according to an exemplary embodiment,

FIGS. 2 to 5 show in each case schematic illustrations of an arrangement during the installation according to an exemplary embodiment, and

FIGS. 6 to 13 show in each case a schematic illustration of an arrangement according to an exemplary embodiment.

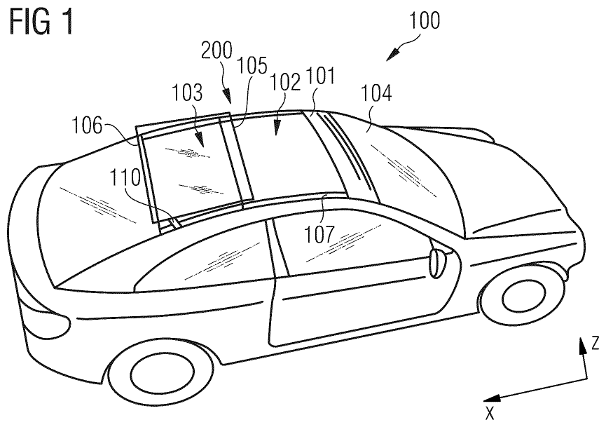

FIG. 1 shows a vehicle 100 according to an exemplary embodiment. The vehicle 100 has a vehicle roof 101. A cover 103 is arranged on the vehicle roof 101. The cover 103 can, for example, be moved relative to the remaining vehicle roof 101. Consequently, a roof opening 102 can be either closed or partially released by the cover 103.

The vehicle has a windshield 104. The cover 103 has a front edge 105 which in the operating state faces the windshield 104. A rear edge 106 of the cover 103 faces away from the windshield 104 in a longitudinal direction X.

The movement of the cover 103 is produced by means of a deployment mechanism. The deployment mechanism has, for example, a guide rail 107 which is connected to the vehicle roof 101. A drive cable is, for example, guided in the guide rail 107. The drive cable is, for example, in contact with an electric drive motor and other components of the deployment mechanism in order to move the cover 103 relative to the remaining vehicle roof 101. The deployment mechanism has an arrangement 200 which will be explained in greater detail below.

For example, the arrangement 200 is configured in the manner of a spoiler roof. The arrangement 200 has a deployment lever 110 which is in particular in the form of a rear deployment lever 110. The rear deployment lever 110 serves to raise and lower the rear edge 106 of the cover 103. When the cover 103 is displaced in the X direction relative to the remaining vehicle roof 101 into the open position, the rear deployment lever 110 is locked with the guide rail. The cover 103 is displaced relative to the deployment lever 110 in the X direction in order to be displaced into the open position thereof. In this regard, the exemplary embodiment of a spoiler roof differs from the exemplary embodiment which is shown in FIG. 1. In FIG. 1, a so-called externally guided sliding roof is illustrated, in which the deployment lever 110 is displaced at the rear edge 106 of the cover 103 together with the cover 103 relative to the remaining vehicle roof in the opening direction. With this type of sliding roof and with other embodiments of sliding roofs, the arrangement 200 described in this instance and the installation method can also be used correspondingly.

Location indications or direction indications used, such as rear or front, top or bottom, left or right, refer to a longitudinal vehicle axis and a conventional travel direction of an operationally ready vehicle 100. The longitudinal vehicle axis may also be referred to as a horizontal axis or X axis in the associated X direction. The transverse vehicle axis may also be referred to as a horizontal axis or Y axis in the associated Y direction. The vertical vehicle axis may also be referred to as a vertical axis or Z axis in the associated Z direction. The vertical direction, the transverse direction and the longitudinal direction are in particular orientated in each case perpendicularly to each other.

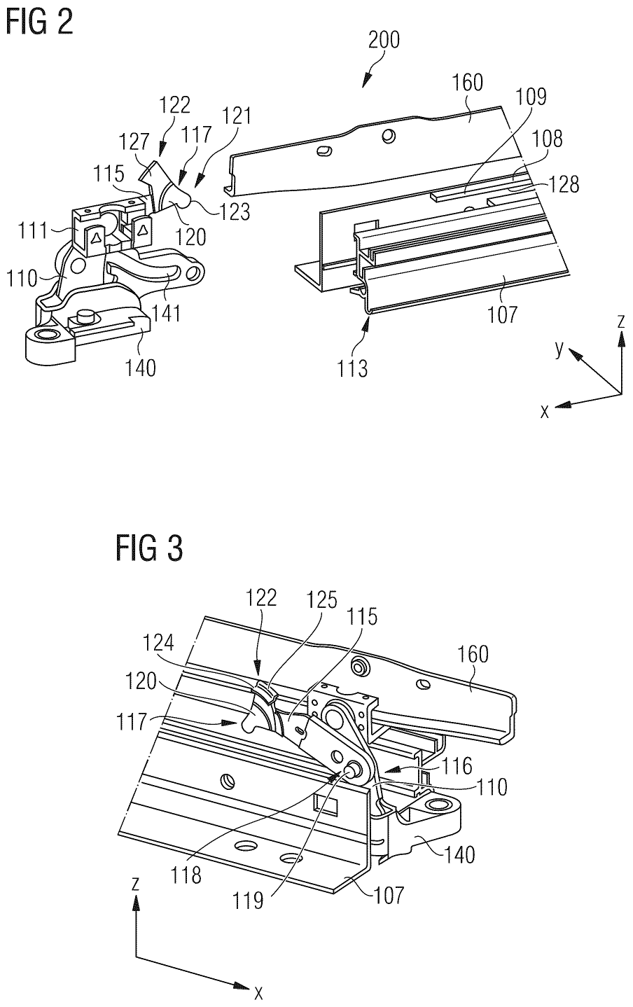

FIG. 2 shows the arrangement 200 before the deployment lever 110 is mounted on the guide rail 107.

The deployment lever 110 is coupled to a deployment bearing 140 so that the deployment lever 110 is retained in a pivotable manner. A drive lever 115 is pivotably connected to the deployment lever 110. In particular, the drive lever 115 is connected to the deployment lever 110 in a central region of the deployment lever 110. A rotational connection 118 (FIG. 3) is formed between the deployment lever 110 and the drive lever 115.

The drive lever 115 has a first end 116 and a second end 117. The rotation connection 118 is formed on the first end 116 of the drive lever 115.

A guide element 120 is formed at the opposing second end 117 of the drive lever 115. The guide element 120 is in particular made from a plastics material. At the second end 117 of the drive lever 115, consequently, a plastics material member 127 is arranged. The plastics material member 127 is, for example, injection-molded on a metal portion of the drive lever 115. The plastics material member 127 is configured to be retained and guided in the guide rail.

In a first step, the guide rail 107 and the deployment bearing 140 are provided with the deployment lever 110 mounted thereon separately from each other. In addition, a cover carrier 160 which carries the cover 103 and which acts as an interface for securing the cover 103 is provided. The cover carrier 160 is, for example, guided and supported in the region of the front edge 105 in the guide rail 107.

The cover carrier 160 is coupled to a cover slider 111 during the installation. The cover slider 111 is arranged at one end of the deployment lever 110. By means of the cover slider 111, the cover 103 is supported by means of the cover carrier 160 on the deployment lever 110 and consequently on the guide rail 107. By pivoting the deployment lever 110, the cover carrier 160 can consequently be raised and lowered in the Z direction relative to the guide rail 107.

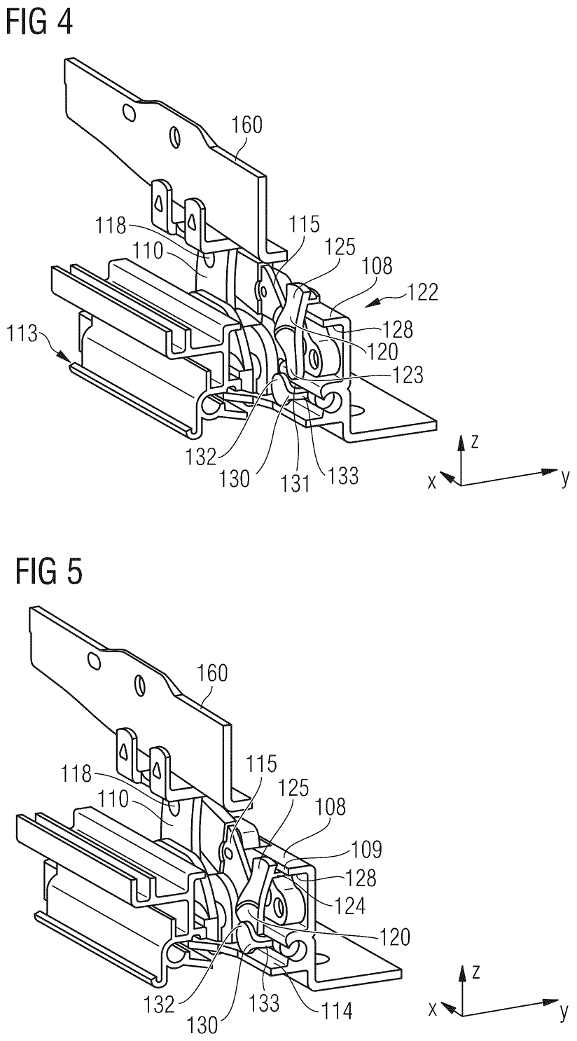

A bearing carriage 130 (for example, FIG. 4) is provided in the guide rail 107. The bearing carriage 130 is guided in the guide rail 107 so as to be able to be displaced in the longitudinal direction X. The bearing carriage 130 is, for example, part of a longitudinally displaceable rotary bearing. The bearing carriage 130 is, for example, made of plastics material. The bearing carriage 130 is retained and guided in the guide rail so that a movement in the X direction is possible and a movement in the Z direction and in the Y direction is blocked.

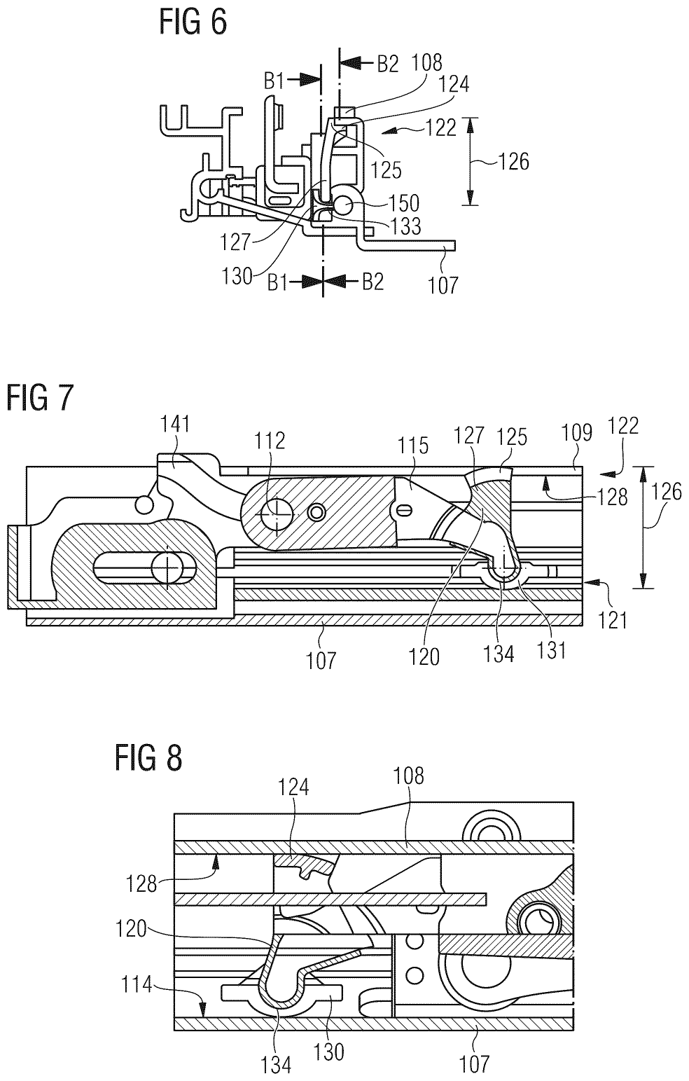

As illustrated, for example, in FIG. 6, the bearing carriage 130 has a connection 133 to a locking element 150. For example, the locking element is a twistable rod. The locking element 150 can, for example, be coupled to a drive carriage (not explicitly shown). The drive carriage in turn can, for example, be coupled to a drive of the arrangement 200 in order to pivot the cover 103 and to displace it in the longitudinal direction.

The locking element 150 can be locked either to the guide rail 107 or to the drive carriage. By means of the locking element 150, a longitudinal movement of the drive carriage relative to the guide rail 107 can be transmitted to the bearing carriage 130. By means of the locking element 150, a locking action relative to the guide rail 107 is possible so that a longitudinal movement of the bearing carriage 130 relative to the guide rail 107 is blocked.

FIG. 3 shows the arrangement 200 during assembly when the deployment bearing 140 is coupled to the guide rail 107. The cover carrier 160 is coupled to the cover slider 111. The deployment lever 110 is in its deployed position, in which the deployment lever 110 extends substantially in the vertical direction Z. In the operationally ready state, in this position the rear edge 106 of the cover 103 is raised.

The drive lever 115 is orientated in such a manner that the guide element 120 is not arranged in the guide rail 107. The drive lever 115 is not yet coupled to the bearing carriage 130. Firstly, the deployment lever 110 is thus connected to the guide rail 107. Subsequently, the drive lever 115 is connected to the bearing carriage 130, as illustrated in FIGS. 4 and 5.

The drive lever 115 is pivoted about its rotation axis 112 (FIG. 7) of the rotary connection 118 so that the guide element 120 moves toward the guide rail 107.

In order to introduce the guide element 120 into the guide rail, the second end 117 is redirected in the Y direction relative to the guide rail 107. Consequently, the guide element 120 is moved in particular away from a guide wall 108. The deployment lever 110 is consequently redirected in particular at the second end 117 thereof from the rest and operating position thereof so that the guide element 120 can be moved past the guide wall 108 and other projections of the guide rail 107 in the direction of the bearing carriage 130. Alternatively or additionally, it is also possible to redirect a portion of the guide rail 107, in particular the portion with the guide wall 108, in the transverse direction so that the guide element 120 can be moved in the direction of the bearing carriage 130. The guide wall 108 may also be referred to as a guide web or guide flange.

The relative redirection of the guide element 120 and the guide rail 107 away from each other is in particular sufficiently large to move a projection 124, which protrudes in the transverse direction Y, of the guide element 120 past the guide wall 108. The projection 124 may also be referred to as a bearing web.

As soon as the projection 124 has been moved past the guide wall 108 (FIG. 5), the guide element 120 and/or the guide rail 107 move back into the rest and operating position so that the projection 124 is arranged below the guide wall 108. The projection 124 is then supported in the Z direction on a horizontal guide path 128, which faces the bearing carriage 130, of the guide wall 108. The horizontal guide path 128 extends in the transverse direction Y, in particular in an X-Y plane. The horizontal guide path 128 guides the guide element 120 in the vertical direction Y. The horizontal guide path 128 supports the guide element 120 axially in the vertical direction Z.

In the Z direction, the position of the guide element 120 is defined in an upward direction by the projection 124 and the guide wall 108. The projection 124 can slide along the guide wall 108 in the X direction.

At the second end 117, the guide element 120 is supported in the transverse direction Y by means of a stop 125 on a vertical guide path 109 of the guide wall 108. The vertical guide path 109 extends in the vertical direction Z, in particular in an X-Z plane. The vertical guide path 109 guides the guide element 120 horizontally in the transverse direction Y. The vertical guide path 109 supports the guide element 120 axially in the transverse direction Y. The stop 125 protrudes in the Z direction beyond the projection 124 in order to guide the guide element 120 at the second end 122 thereof in the Y and Z direction on the guide rail 107 in a defined manner.

At an opposing first end 121 of the guide element 120, a bearing projection 123 of the guide element 120 is introduced into a recess 131 of the bearing carriage 130. The bearing carriage 130 has a protruding region 132 which protrudes in the Z direction beside the recess 131. In order to introduce the bearing projection 123, the bearing projection 123 is guided in the protruding region 132 and thus reaches the recess 131 in a reliable manner. For example, the bearing projection 123 is already in contact with the protruding region 132 when the projection 124 does not yet engage behind the guide wall 108. Consequently, the second end 122 can be redirected relative to the guide rail 107 in the transverse direction X, whilst the first end 121 of the guide element 120 is supported on the protruding region 132.

The coupling of the guide element 120 with the bearing carriage 130 is configured in such a manner that a movement of the bearing carriage 130 in the longitudinal direction X relative to the guide rail 107 is transmitted to the guide element 120. Consequently, the guide element 120 and consequently the drive lever 115 can be displaced by the bearing carriage 130 in the longitudinal direction X relative to the guide rail 107. This displacement of the drive lever 115 in turn leads to a pivoting of the deployment lever 110.

At the first end 121, the guide element 120 is supported on a base 134 (FIG. 7) of the recess 131 in the Z direction. The base 134 may also be referred to as the lower bearing segment.

In the Z direction, the guide element 120 is consequently supported in a downward direction on the base 134 of the recess 131 of the bearing carriage 130 and in an upward direction by means of the projection 124 on the guide path 128 of the guide rail 107. By means of the protruding region 132 and the stop 125, the guide element 120 is positioned in a defined manner in the transverse direction Y.

The arrangement 200 can be installed in a simple and reliable manner. The guide rail 107 can be coupled to the bearing carriage 130. Independently of this, the deployment bearing 140 can be coupled to the deployment lever 110 and the drive lever 115. Only afterwards are the two sub-assemblies mounted together. The drive lever 115 can be introduced by means of the redirection or the slight resilient deformation into the guide rail 107 and coupled to the bearing carriage 130. As a result of the projection 124, the stop 125 and the bearing projection 123, the drive lever 115 is retained in a reliable and comparatively play-free manner. By means of the engagement of the bearing projection 123 in the recess 131, a movement of the bearing carriage 130 can further be transmitted to the drive lever 115 in a reliable manner.

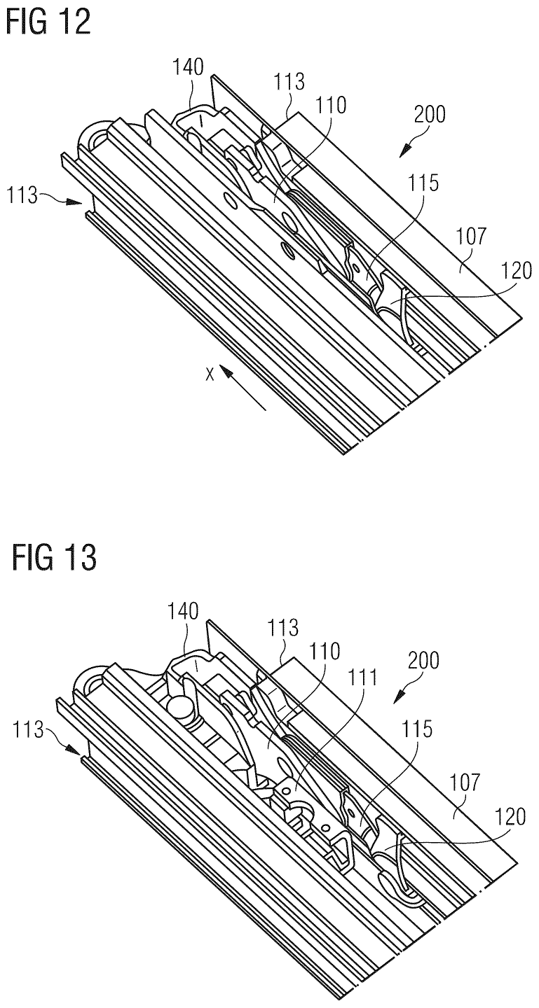

FIGS. 6 to 13 show other views and sectioned illustrations of the arrangement 200.

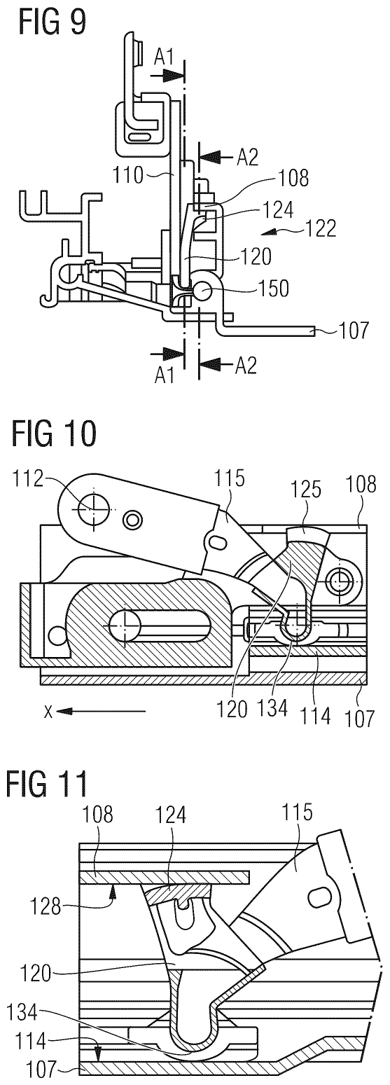

As can be seen in particular in FIGS. 6 and 9, the plastics material member 127 is supported in a reliable manner in the Z direction between the guide rail 107 on the guide wall 108 and the bearing carriage 130. The guide element 120 or the plastics material member 127 extends in a longitudinal extent 126 (FIGS. 6 and 7). In the longitudinal extent 126, the plastics material member 127 is supported at the first end 121 by means of the bearing carriage 130 on the guide rail 107. In the longitudinal extent 126, the plastics material member 127 is supported at the second end 122 by means of the projection 124 and the stop 125 directly on the guide rail 107.

The deployment lever 110 has a pin 119 (FIG. 3) which is guided in a slotted deployment member 141 (FIG. 7). The pin 119 may also be referred to as a bearing pin. The slotted deployment member 141 is in particular formed in the deployment bearing 140 and serves to pivot the deployment lever 110 as desired during a movement of the drive lever 115 in the longitudinal direction X.

For example, FIGS. 7, 8, 10 and 11 show that the recess 131 and accordingly the bearing projection 123 are formed in order to enable an easy pivoting of the drive lever 115 whilst the deployment lever 110 is being pivoted. Nonetheless the recess 131 is formed in such a manner that the movement forces can be reliably transmitted in the longitudinal direction X.

As can be seen in particular in FIGS. 12 and 13, in the operationally ready state the deployment bearing 140 is mounted at a rear end 113 of the guide rail 107. The drive lever 115 extends forward in the X direction and is retained and guided in the guide rail at the front second end 117 thereof by means of the guide element 120.

For assembly, the drive lever 115 is pressed resiliently in the Y direction into the guide rail 107 so that the guide element 120 snap-fits into the guide rail 107. For assembly, either the guide rail 107, the drive lever 115 or both are temporarily resiliently deformed in order to bring about the engagement of the projection 124 behind the guide wall 108.

On the whole, the arrangement 200 can be mounted in a reliable and simple manner and requires comparatively little structural space.

### LIST OF REFERENCE NUMERALS

100 Vehicle
101 Vehicle roof
102 Roof opening
103 Cover
104 Windshield
105 Front edge
106 Rear edge
107 Guide rail
108 Guide wall
109 Vertical guide path
110 Deployment lever
111 Cover slider
112 Rotation axis
113 End of the guide rail
115 Drive lever
116 First end
117 Second end
118 Rotary connection
119 Pin
120 Guide element
121 First end of the guide element
122 Second end of the guide element
123 Bearing projection
124 Projection
125 Stop
126 Longitudinal extent
127 Plastics material member
128 Horizontal guide path
130 Bearing carriage
131 Recess
132 Protruding region
133 Connection
134 Base
140 Deployment bearing
141 Slotted deployment member
150 Locking element
160 Cover carrier
200 Arrangement
X Longitudinal direction
Y Transverse direction
Z Vertical direction

1. An arrangement for moving a cover for a vehicle roof, having:
a guide rail which extends in a longitudinal direction,
a deployment lever for raising a rear edge of the cover,
a bearing carriage which is retained in the guide rail so as to be able to be displaced in the longitudinal direction,
a drive lever which is rotatably coupled at a first end to the deployment lever and which has at a second end a guide element, wherein the guide element is supported between the bearing carriage and the guide rail in order to transmit a movement of the bearing carriage in the longitudinal direction to the deployment lever.

2. The arrangement according to claim 1, wherein the guide element has at a first end a bearing projection which is arranged in a recess of the bearing carriage and which is supported on a base of the recess.

3. The arrangement according to claim 1, wherein the guide element has at a second end a protruding projection, wherein the second end is opposite the first end in a longitudinal extent of the guide element, and wherein the projection protrudes transversely relative to the longitudinal extent and is supported on the guide rail.

4. The arrangement according to claim 1, wherein the guide element has at the second end thereof a stop which is supported on a vertical guide path of the guide rail.

5. The arrangement according to claim 1, wherein the guide element at the second end thereof is in direct contact with the guide rail.

6. The arrangement according to claim 1, wherein the guide element has a plastics material member which is supported between the bearing carriage and the guide rail.

7. The arrangement according to claim 1, wherein the bearing carriage has a connection to a locking element which in a first state can be displaced in the longitudinal direction relative to a guide rail and in a second state is locked against a movement in the longitudinal direction relative to the guide rail.

8. The arrangement according to claim 1, wherein the bearing carriage has a protruding region which laterally supports the guide element.

9. A method for installing an arrangement for moving a cover for a vehicle roof, comprising:
providing a guide rail which extends in a longitudinal direction,
providing a bearing carriage which is retained in the guide rail so as to be able to be displaced in the longitudinal direction,
providing a deployment lever having a drive lever which is rotatably coupled at a first end to the deployment lever and which has at a second end a guide element,
moving the guide element in a vertical direction in the direction of the deployment lever, wherein the vertical direction is orientated transversely relative to the longitudinal direction,
redirecting a second end of the guide element and of the guide rail in a transverse direction relative to each other, wherein the second end of the guide element faces away from the bearing carriage, wherein the transverse direction is orientated transversely relative to the longitudinal direction and the vertical direction,
inserting a first end of the guide element into the bearing carriage, and
pivoting the second end of the guide element into the guide rail, and thereby
arranging the guide element between the bearing carriage and the guide rail so that the guide element is supported between the bearing carriage and the guide rail.

10. The method according to claim 9, comprising:
inserting a deployment bearing with the deployment lever into the guide rail before inserting the first end of the guide element into the bearing carriage.
